(19) United States
(12) Patent Application Publication
(10) Pub. No.: US 2009/0025520 A1
(43) Pub. Date: Jan. 29, 2009

(54) Circular saw stand

(75) Inventors: Viktor Heinrichs, Untermeitingen (DE); Johannes Stempfhuber, Landsberg (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/220,641

(22) Filed: Jul. 24, 2008

(30) Foreign Application Priority Data
Jul. 27, 2007 (DE) 10 2007 000 409.7

(51) Int. Cl. B26D 7/00; B26D 7/02

(52) U.S. Cl. 83/471; 83/452

(57) ABSTRACT

A circular saw stand (2) for effecting cuts with a hand-held circular saw (4), includes a device (6) for securing the circular saw stand (2) on a work table (10), a locking device (12) for adjustably defining a region (14) for receiving a to-be-cut workpiece (16) and having two clamping elements one of which is connected with the securing device (6) and another one is located opposite the one clamping element and displaceable relative thereto, and a guide device (42) forming a guide plane for a bearing plate (40) of the circular saw (4) and supported on one of the clamping elements.

### BACKGROUND OF THE INVENTION

1. Field of the Invention

The present invention relates to a circular saw stand for effecting cuts with a hand-held circular saw and including a device for securing the stand on a work plate, a region for receiving a to-be-cut workpiece and a guide device that forms a guide plane for a bearing plate of the circular saw.

2. Description of the Prior Art

With circular saw stands of the type discussed above, a to-be-cut workpiece is arranged and secured in the receiving region in a desired position. Then, a cut can be made, with a conventional circular saw, along the guide device, with the bearing plate of the circular saw being placed on the guide plane and being displaced therealong. This makes a particularly precise cut possible.

International Publication WO 03/041907 discloses a device for guiding a hand-held saw. The guiding device has two extending parallel to each other guide rails, with respective opposite edge regions of the bearing plate of the saw lying on the rails, respectively. The guide rails are held at their ends on a work table with a securing device formed of console elements, with the console elements forming, respectively, height-adjustable threaded connections with the work table.

The drawback of the guiding device described above consists in that the device can be adjusted in accordance with different heights of the to-be-cut workpieces only after releasing and tightening anew of all of four threaded connections. Further, with the above-described guiding device, for securing a workpiece, essentially only the flat surface of the work table is used which makes it difficult to cut, in particular, workpieces having a circular cross-section and which makes it necessary to use, e.g., additional means for reliably securing a workpiece. This, however, further increases the operational expenses.

Accordingly, an object of the present invention is to provide a circular saw stand in which the drawbacks of the known circular saw stand are eliminated.

Another object of the present invention is to provide a circular saw stand which would insure a comfortable and rapid adjustment for differently dimensioned workpieces and a reliable securing of a workpiece, in particular, of a workpiece having a circular cross-section.

### SUMMARY OF THE INVENTION

This and other objects of the present invention, which will become apparent hereinafter, are achieved by providing a circular saw stand in which a locking device adjustably defines the region for receiving a to-be-cut workpiece and has a first clamping element fixedly connected with the securing device and a second clamping element located opposite the first clamping element and displaceable relative thereto, and the guide device which forms the guide plane for a bearing plate of the circular saw, is supported on one of the first and second clamping elements. The locking device makes it possible to reliably secure the to-be-cut workpiece on the circular saw stand, and a direct connection of the locking device with the guide device provides for a particularly simple and compact construction of the circular saw stand and for comfortable and rapid adjustment for a to-be-cut workpiece.

According to a particularly advantageous embodiment of the inventive circular saw stand the displaceable clamping element is adjusted relative to the fixed clamping element with a single handle. This enables a particularly comfortable and rapid adjustment of the inventive circular saw stand so that it becomes easily adaptable to differently dimensioned workpieces.

Advantageously, the guide plane is formed by a single guide plate of the guide device. This insures a compact construction and an exact guidance.

According to a further advantageous embodiment of the present invention the displaceable clamping element is formed by a clamping sling and the first clamping element is formed by a stop side of a frame that carries the guide device. This insures fixing of workpieces which have a circular cross-section or a cross-section with more than four sides.

Advantageously, the single handle is formed by a thread element, and the clamping sling is tightened by a tension member linearly displaceable by the thread element. Thereby, the clamping sling is particularly simply adjusted between the locking and release positions.

According to an alternative advantageous embodiment of the present invention, the first clamping element is formed by a first clamping jaw and the second clamping element is formed by a second clamping jaw displaceable relative to the first clamping jaw and arranged on a carrier that carries the guide device.

Thereby, a particularly reliable locking of workpieces with a square or rectangular cross-section is insured.

It is particularly advantageous when the carrier is displaced between the locking and release positions with a pivotal locking lever, which enables a particularly rapid adjustment of the locking device between its locking and release positions.

It is advantageous when the clamping jaws have, respectively, two, extending in opposite directions, inclined clamping surfaces, which permits additionally to reliably secure workpieces with a substantially circular cross-section.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a schematic view of a first embodiment of a circular saw stand according to the present invention; and

FIG. 2 a schematic view of a second embodiment of a circular saw stand according to the present invention.

### DETAILED DESCRIPTION OF THE PREFERRED EMBODIMENT

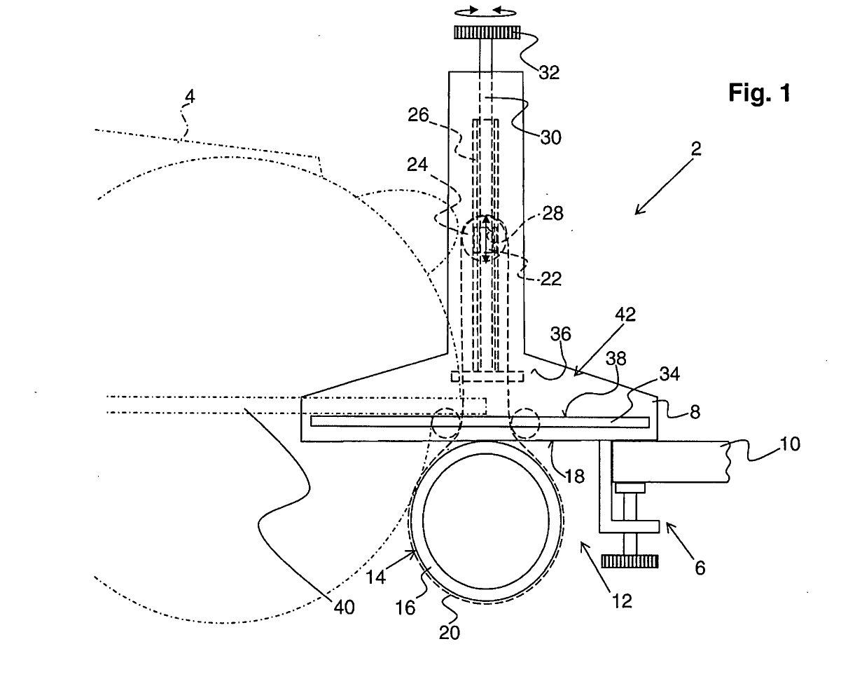

A circular saw stand 2 according to the present invention, which is shown in FIG. 1, is designed for producing cuts with hand-held circular saw 4. The circular saw stand 2 has a securing device 6 in form of a screw clamp with which a frame 8 of the circular saw stand 2 can be secured on a work plate 10 that forms, e.g., a component of work table.

The circular saw stand 2 has a locking device 12 that defines a receiving region 14 in which a workpiece 16, e.g., in form of a pipe can be secured. The locking device 12 has a fixed locking element which is formed by a stop side 18 of the frame 8, and a displaceable element which is formed by a locking sling 20. The locking sling 20 can be formed by a rope-, strip-, or chain-shaped element that can have, in accordance with an intended field of use, a certain elasticity.

For locking and releasing the locking device 12, there is provided, on the frame 8, a translationally displaceable tension member in form of a groove block that surrounds the locking sling 20 with aid of an intermediate deflection member 24. The groove block is displaceable in a groove 26 without a possibility of rotation relative thereto and has a threaded bore 28 through which a threaded rod 30 extends which can be rotated from outside with a handle formed as a knurled wheel 32 and with which the groove block cooperates. The rotation of the knurled wheel 32 causes displacement of the tension member 22 in opposite directions, which leads to widening or diminishing of the receiving region 14, whereby the locking device 12 is displaced between its locking position in which it secures the to-be-cut workpiece 16, and its release position in which the treated workpiece 16 can be removed from the locking device 12.

For guiding the circular saw 4 during a cutting process, a guide plate 34 projects from end side 36 of the frame 8 perpendicular thereto. The upper surface 38 of the guide plate 34 forms a closed guide plane for a bearing plate 40 of the circular saw 4. In this way, the guide plate 34 forms, together with the end side 36 of the frame 8, a guide arrangement 42 along which the circular saw 4 can be reliably guided during a cutting process.

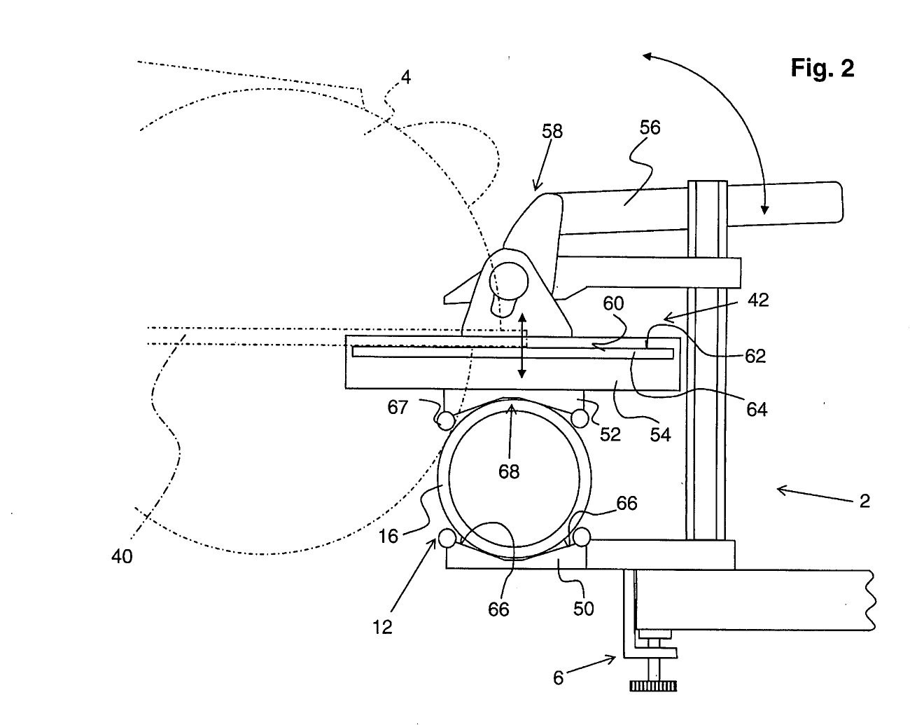

FIG. 2 shows another embodiment of the circular saw stand 2 according to the present invention and in which the parts with the corresponding functions are designated with the same reference numeral as in FIG. 1.

The main difference of the embodiment of the circular saw stand 2 shown in FIG. 2 from that described with reference to FIG. 1 consists in that the locking device 12 has a first clamping jaw 50 that functions as a stationary locking element, and a second clamping jaw 52 that functions as a displaceable locking element.

The first clamping jaw 50 is fixedly connected with the securing device 6, whereas the second clamping jaw 52 is arranged on a carrier 54 displaceable in opposite directions in the locking and release positions of the locking device 12 by a locking lever 56, which functions as a handle of a quick locking device 58.

In this case, the guide device 42 is formed by an end surface 60 of the carrier 54 and the upper surface 62 of a guide plate 64 that projects perpendicular to the end surface 60.

Functionwise, the embodiment according to FIG. 2 is substantially similar to the embodiment of FIG. 1. Actually, only securing of the to-be-cut workpiece 16 is effected.

In order to be able to reliably secure, in addition to workpieces 16 having a rectangular cross-section, as shown, also workpieces with a circular cross-section, both clamping jaws 50, 52 have, respectively, two, extending in opposite direction and inclined towards each other clamping surfaces 66 that form a depression 68 for reliably securing the workpiece 16. In addition, on outer rims of both clamping jaws 50, 52, there are provided, respectively, two clamping rollers 67, whereby pipes having a larger diameter (larger than the cut depth of the circular saw) are locked with a possibility of rotation so that they can be cut through circumferentially.

For carrying out the cutting process, the bearing plate 40 of the circular saw 4 only need to abut the guide plate 64 and is displaced thereover, while the end surface 60 provides for a sidewise guidance.

Though the present invention was shown and described with references to the preferred embodiment, such is merely illustrative of the present invention and is not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A circular saw stand (2) for effecting cuts with a hand-held circular saw (4), comprising:
a device (6) for securing the circular saw stand (2) on a work table (10);
a locking device (12) for adjustably defining a region (14) for receiving a to-be-cut workpiece (16) and having a first clamping element fixedly connected with the securing device (6) and a second clamping element located opposite the first clamping element and displaceable relative thereto; and
a guide device (42) forming a guide plane for a bearing plate (40) of the circular saw (4) and supported on one of the first and second clamping elements.

2. A circular saw stand according to claim 1, comprising a single handle for displacing the second clamping element relative to the first clamping element.

3. A circular saw stand according to claim 1, wherein the guide plane is formed by a single guide plate (34) of the guide device (42).

4. A circular saw stand according to claim 2, wherein the second clamping element is formed by a clamping sling (20), and the first clamping element is formed by a stop side (18) of a frame (8) that carries the guide device (42).

5. A circular saw stand according to claim 4, wherein the single handle is formed by a thread element, and the clamping sling (20) is tightened by a tension member (22) linearly displaceably by the thread element.

6. A circular saw stand according to claim 1, wherein the first clamping element is formed by a first clamping jaw (50), and the second clamping element (52) is formed by a second clamping jaw (52) displaceable relative to the first clamping jaw (50) and arranged on a carrier (54) that carries the guide device (42).

7. A circular saw stand according to claim 6, further comprising a pivotal locking lever (56) for displacing the carrier (54) between a locking position and release position.

8. A circular saw stand according to claim 6, wherein the clamping jaws (50, 52) each has a depression.
